(19) United States
(12) Patent Application Publication
(10) Pub. No.: US 2025/0262595 A1
(43) Pub. Date: Aug. 21, 2025

(54) SURFACE CARBON MINERALIZATION PROCESS USING PETROLEUM REFINERY SOLID WASTE MATERIAL

(71) Applicant: Chevron U.S.A. Inc., San Ramon, CA (US)

(72) Inventors: Francisco Lopez-Linares, Vallejo, CA (US); Cesar Francisco Ovalles, Walnut Creek, CA (US); Babak Fayyaz Najafi, Alamo, CA (US); Mauricio Molina, Pleasanton, CA (US); Harris Mauricio Roberto Morazan Flores, Antioch, CA (US)

(21) Appl. No.: 19/055,426

(22) Filed: Feb. 17, 2025

Related U.S. Application Data
(60) Provisional application No. 63/554,089, filed on Feb. 15, 2024.

(51) Int. Cl. B01D 53/62; B01D 53/81; C01F 7/782

(52) U.S. Cl. CPC B01D 53/62; B01D 53/81; C01F 7/782; B01D 2251/304; B01D 2251/402; B01D 2251/404; B01D 2251/604; B01D 2251/902; B01D 2257/504; B01D 2258/0283; B01D 2258/06

(57) ABSTRACT

A process for carbon mineralization of petroleum refinery solid waste material includes providing an aluminum (Al)-containing industrial solid waste generated within a petroleum refinery, a carbon dioxide (CO₂) containing stream, and an alkali base to a mineralization reactor. The petroleum refinery solid waste material includes the aluminum-containing industrial solid waste. The process also includes reacting the Al-containing industrial solid waste, the CO₂ containing stream, and the alkali base within the mineralization reactor under reaction conditions to produce a reactor product comprising an Al-containing carbonate product.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Carbon dioxide capture and sequestration (CCS) includes a portfolio of technologies that can potentially capture CO₂ with the aim of reducing the emissions of industrial facilities. Mineral carbonation (MC) (also referred to as carbon mineralization (CM)) is emerging as a potential CCS technology solution to sequester CO₂ from certain emitters where geological sequestration is not viable. In MC processes, CO₂ chemically reacts with calcium- and magnesium-containing materials to form thermodynamically stable carbonates [1]. This reaction can occur below (in situ) or above (ex-situ) ground. In situ, MC involves the injection of CO₂ into underground reservoirs to promote the reaction between CO₂ and alkaline minerals present in the geological formation to form carbonates, with the concomitant storage of carbon dioxide in the time frames of decades to centuries. The MC reaction is spontaneous and exothermic and can be exemplified in equations (1) and (2), where calcium and magnesium oxides are considered to react with CO₂.

CaO+CO₂→CaCO₃+179 KJ mol⁻¹ (1)

MgO+CO2→MgCO₃+118 kJ mol⁻¹ (2)

The most reactive compounds for CO₂ mineralization are oxides of divalent metals, e.g., Ca and Mg. Their availability in nature is mainly in the form of silicates, such as olivine ((Mg,Fe)₂SiO₄) orthopyroxene (Mg₂Si₂O₆—Fe₂Si₂O₆), clinopyroxene (CaMgSi₂O₆—CaFeSi₂O₆) and serpentine ((Mg,Fe)₃Si₂O₅(OH)₄), the latter resulting from the hydration of olivine.

When CO₂ dissolves in water, it reacts with these silicates, forming corresponding carbonates, where CO₂ is fixed in a mineral form. Reactions based on sodium and potassium bicarbonate also function in the presence of water (eq. 3) and have been investigated as low-temperature sorbents (<373 K). Support systems are typically applied to enhance the carbonation and regeneration kinetics by maximizing the adsorption surface.

(Na,K)₂CO₃+CO₂+H₂O→2(Na,K)HCO₃ (3)

Ex situ mineral carbonation focuses on metal oxide (such as calcium and magnesium) bearing materials whose corresponding carbonates are insoluble in water. Moreover, since calcium-oxide-rich waste materials are sometimes conveniently located close to CO₂ emission sources, they have also been considered feedstocks for CM. The chemistry applied to in situ mineralization processes can also be used for ex-situ counterparts.

Under reservoir conditions, it is possible to produce the mineral type known as Dawsonite (eq. 4), a hydrated sodium aluminum carbonate with a general chemical formula of MAl(CO₃)(OH)₂, where M═Na or K. Carbon capture in Dawsonite in mineral formations accounts for 42.2%-90.1% of the total carbon geological sequestration. The formation of Dawsonite-type compounds (an aluminum-containing carbonate product) is affected by various factors, such as precursor minerals, rock types, pH, and the partial pressure of carbon dioxide (CO₂).

MAlO₂+CO₂+H₂O→MAlCO₃(OH)₂, where M═Na or K (4)

### BRIEF DESCRIPTION OF DRAWINGS

These and other objects, features and advantages of the present disclosure will become better understood with reference to the following description, appended claims and accompanying drawings, wherein:

FIG. 1 is a process flow diagram depicting a surface carbon mineralization process using aluminum-containing industrial waste, CO₂, alkali base, and additives in accordance with embodiments of this disclosure;

FIG. 2 is a process flow diagram depicting a surface carbon mineralization process using fluid catalytic cracking (FCC) catalyst fines, CO₂, alkali base, and additives in accordance with an embodiment of this disclosure;

FIG. 3 is a process flow diagram depicting a surface carbon mineralization process using FCC catalyst fines, alkaline solid industrial wastes, CO₂, alkali base, and additives in accordance with an embodiment of this disclosure;

FIG. 4 is a process flow diagram depicting a surface carbon mineralization process using spent hydrotreated catalyst, CO₂, alkali base, and additives in accordance with an embodiment of this disclosure;

FIG. 5 is a process flow diagram depicting a surface carbon mineralization process using spent hydrotreated catalyst, alkaline solid industrial wastes, CO₂, alkali base, and additives in accordance with an embodiment of this disclosure; and

FIG. 6 is a process flow diagram depicting a surface carbon mineralization process using FCC catalyst fines, CO₂, alkali base, and additives in accordance with an embodiment of this disclosure.

### DESCRIPTION OF THE INVENTION

Outside of reservoir conditions, natural Dawsonite forms in the 25-200° C. temperature range, while artificial Dawsonite can be synthesized in the temperature range of 60-180° C. It is now recognized that it is possible to mimic the formation of Dawsonite-type compounds during ex-situ mineralization by combining suitable solid refinery waste with CO₂ in the presence of inorganic bases (NaOH or KOH) at relatively mild process conditions (e.g., T<200° C., P<500 psi, and time <3 h). In this way, the capture and storage of carbon dioxide can be effectively accomplished, and the mineralized products have commercial applications in the production of concrete, cement, fillers, and other construction materials.

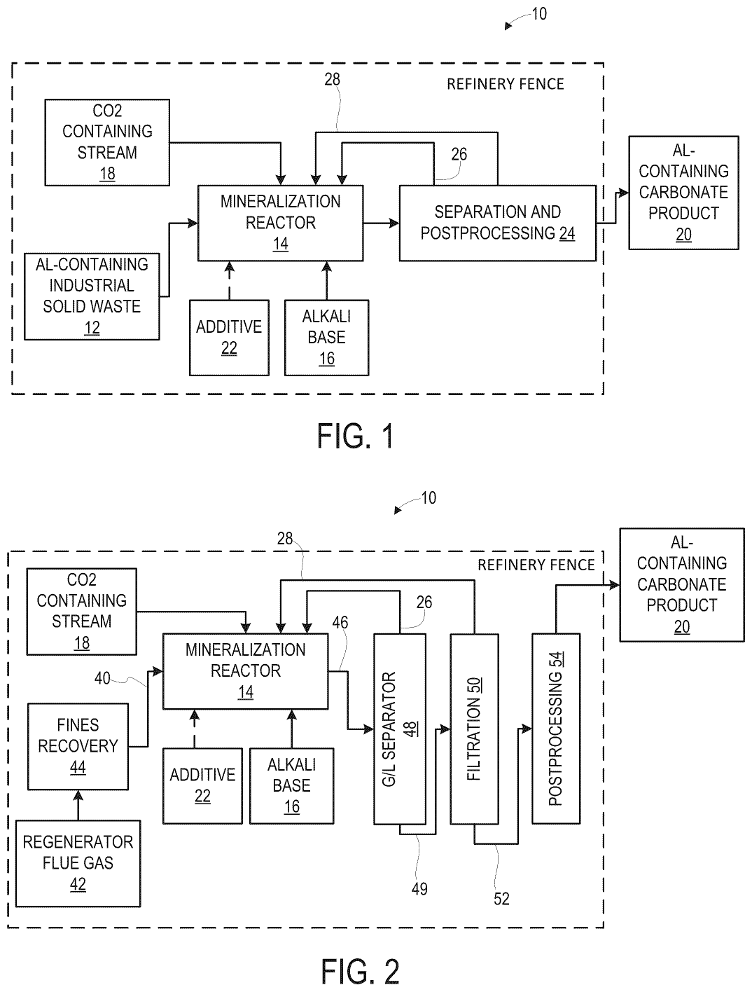

Certain embodiments of this disclosure may be better understood with reference to FIG. 1, which is an example embodiment of a process carried out by a system 10 in which an aluminum-containing industrial solid waste 12 is ultimately used for carbon capture. More particularly, the Al-containing industrial solid waste 12 is provided to a mineralization reactor 14. The mineralization reactor 14 is operated at conditions that facilitate a reaction between the Al-containing industrial solid waste 12, an alkali base 16, and a CO₂ containing stream 18 to produce an aluminum-containing carbonate product 20.

The CO₂ containing stream 18 may be a stream from a variety of sources—including streams generated within a refinery or from outside of the refinery. In some embodiments and by way of non-limiting example, the CO₂ containing stream 18 may be a flue gas stream having between 4% and 20% CO₂ by volume. However, the embodiments of the invention may utilize streams having lower CO₂ concentrations or higher CO₂ concentrations than these.

The chemical identity of the aluminum-containing carbonate product will depend on the particular nature of the Al-containing solid waste 12 and the alkali base 16, and in some embodiments the use of other reagents such as additives 22 as described in further detail below. As shown in FIG. 1, separation and post processing 24 is performed on the mineralization reactor effluent to recycle unreacted CO₂ 26 and unreacted alkali base 28 back to the mineralization reactor 14 and produce a stream of isolated aluminum-containing carbonate product (i.e., an Al-containing carbonate product stream) 20.

In accordance with certain embodiments of this disclosure, suitable solid refinery waste that may be used to perform carbon mineralization (CM) includes solid waste materials from a fluid catalytic cracking process (FCC). That is, the Al-containing industrial solid waste of FIG. 1 may include solid waste materials from such a process. During petroleum refinery operation, catalyst particles used for FCC in oil refineries can undergo attrition, contributing to the production of fines (e.g., particle size <45 μm, such as between 0.5 μm and 45 μm). Advantageously, the smaller particle size relative to the original catalyst size allows for higher conversions at the same residence time, which may contribute to enhanced CO₂ capture/utilization.

Most FCC units have fines recovery systems (e.g., cyclones, filtration, or other) to control the loss of these finely divided solids to the environment. FCC fines constitute a solid waste material that must be handled properly with the concomitant expenses to the refinery operations. Embodiments of this disclosure may allow some of these recovered materials to be used to perform CCS, as described in the embodiments below.

One more specific example embodiment of the invention is shown in FIG. 2. In FIG. 2, catalyst fines 40 are removed from an FCC regenerator flue gas 42 using a fines recovery system 44 (e.g., including a cyclone separator) to fulfill regulatory requirements and to protect downstream equipment. The FCC catalyst fines 40 are Si-based and Al-based materials containing Mg, Ca, and Na as minor or trace elements. The catalyst fines 40 are contacted in the mineralization reactor 14 (in a batchwise or continuous mode) with the carbon dioxide containing stream 18 (from a point source or any other industrial sources) and the alkali base 16 (e.g., 0.1 M to 8 M NaOH or KOH aqueous solution), at mild process conditions (T<200° C., P<500 psi, and time <3 h). For the preparation of the alkali base 16, the water source could be fresh water, refinery-produced water or another water stream. Additionally, additives 22 may be employed in this step to increase the rate of the carbon mineralization reaction, and thus, the efficiency of the process. Suitable additives include ethylene diamine tetraacetate (EDTA), ammonium bases, urea, betanine, and amino acid-bases compounds such as sarcosine, lysine, or any combination thereof. In some embodiments, additives may include transition-metal containing compounds such as Zn, Cu, or Fe in oxide, hydroxide, or chloride form, or any combination of these.

The mineralization reactor 14 produces a slurry phase product 46, which is mostly carbonate rich solids, including but not limited to Dawsonite-type compounds (eq. 4), unreacted alkali, and CO₂. In the case of Dawsonite, it will generally be produced if a stable CO₂ source maintains its partial pressure >10⁻³ bar. Na⁺ and Al³⁺ participate in the complex reaction with bicarbonate ions (HCO₃⁻) to form Dawsonite (NaAlCO₃(OH)₂) in an alkaline environment, as shown in eqs. 5-7:

CO₂+H₂O→H₂CO₃ (5)

H₂CO₃→H⁺+HCO₃⁻ (6)

Na⁺+Al³⁺+HCO₃⁻+H₂O→NaAlCO₃(OH)₂ (7)

In the embodiment of FIG. 2, unreacted carbon dioxide 26 and unreacted alkali base 28 are recycled using a Gas/Liquid separation unit 48 and a filtration apparatus 50, respectively. The G/L separation unit 48 produces a CO₂-lean slurry 49, which is then provided to the filtration apparatus 50. The resulting product from the filtration apparatus 50 is a wet aluminum-containing carbonate product 52, which is then subjected to postprocessing in a postprocessing system 54 to produce the aluminum-containing carbonate product 20. In the postprocessing step, the mineralized product may be dried, pelletized, or agglomerated using any conventional technology, or sold as produced for applications in concrete, cement, and other construction material industries.

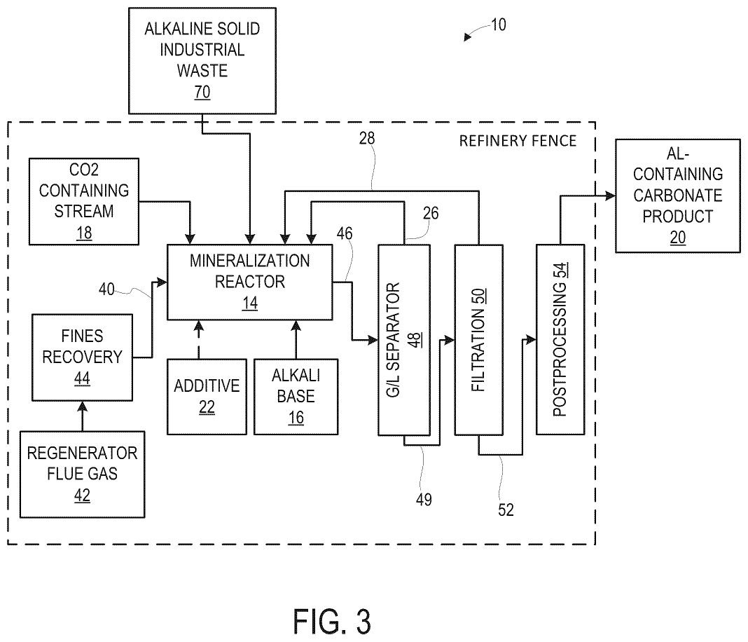

A second example embodiment of the invention is shown in FIG. 3. In this embodiment, an alkaline solid industrial waste 70 from an external source (i.e., outside refinery fence) is fed to the mineralization reactor 14 in a process similar to the one shown in FIGS. 1 and 2. The additional alkaline solid industrial waste may allow larger volumes of CO₂ to be processed with a concomitant increase in greenhouse gas (GHG) reduction, among other benefits. Non-limiting examples of the alkaline solid industrial waste 70 include any one or a combination of mine tailings of alkaline minerals and rocks (e.g., Ca-, Mg-, or Al-containing minerals), alkaline industrial low-value residues from one or more coal-fired power plants, cement, steel, and aluminum industries, and earth abundant alkaline resources. As in the embodiment of FIG. 2, the aluminum-containing carbonate product 20 may be sold after postprocessing or as produced. Further, it should be noted that in certain embodiments, the additional alkaline solid industrial wastes 70 may be generated from within the refinery. Thus, the mineralization reactor 14 may receive FCC catalyst fines 40 and additional alkaline solid industrial wastes 70 generated from within the refinery, generated outside the refinery, or both.

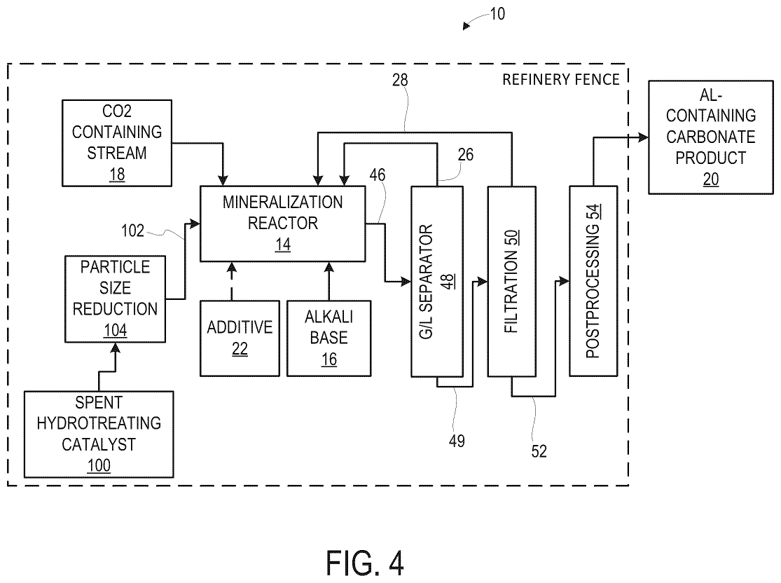

A third example embodiment of the invention is shown in FIG. 4, which may be used alone or in combination with the embodiments of FIGS. 1-3. In this embodiment, the refinery waste material is a spent hydrotreating catalyst 100. A “spent” catalyst generally refers to a solid that has lost at least 50% of its activity in comparison with the fresh catalyst.

These catalyst solids generally include aluminum and silicon with trace amounts of molybdenum, nickel, and sulfur. This composition makes these materials excellent feeds for the surface mineralization process described herein. As shown in FIG. 4, the particle size of the spent hydrotreating catalyst is reduced (<149 μm, such as between 1 nm and 149 μm, between 100 nm and 120 μm, or between 0.5 μm and 1.0 μm) to generate a spent catalyst reactor feed 102 using particle size reduction equipment 104 to improve handling and increase the rate of mineralization. Any conventional technology may be used for the particle size reduction such as impact crushers, milling machines, cage mills, hammer mills, pulverizers, and grinders.

As with the previously described embodiments, in FIG. 4 the waste solid catalyst is reacted with the alkali base 16 and CO₂, optionally in the presence of additives 22, within the mineralization reactor 14 at mild process conditions (e.g., T<200° C., P<500 psi, and time <3 h) to yield, after G/L separation 48, filtration 50, and postprocessing 54, the aluminum-containing mineralized products 20. As before, the aluminum-containing mineralized products may have important applications in concrete, cement, and other construction industries.

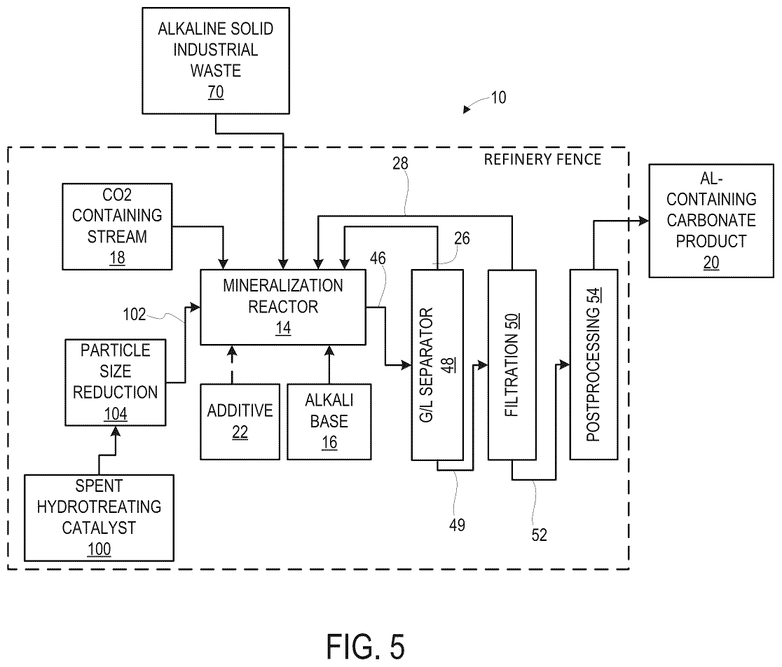

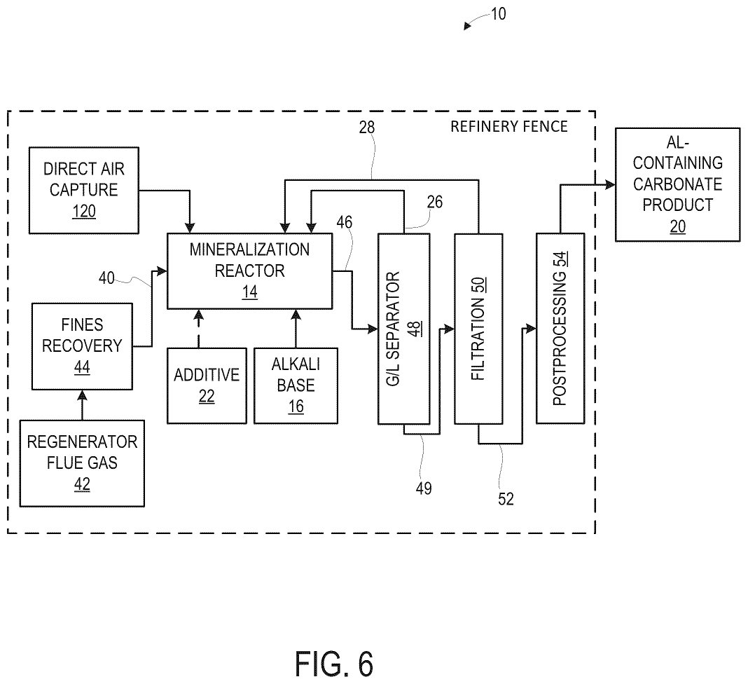

FIG. 5 shows a fourth example embodiment of the invention. In this embodiment, the alkaline solid industrial waste 70 from an external source (i.e., outside refinery fence) is co-processed along with the spent hydrotreating catalyst 100 in the mineralization reactor 14. By incorporating the use of alkaline solid industrial wastes 70 along with the use of spent hydrotreating catalyst 100, it is believed that larger volumes of CO₂ can be consumed with a concomitant increase in GHG reduction. The alkaline solid industrial wastes 70 may include, by way of example, Ca-, Mg-, or Al-containing mine tailings, alkaline industrial low-value residues from one or more coal-fired power plants, cement, steel, and aluminum industries. As in the previous embodiments, the small particle size (e.g., <149 μm) spent hydrotreating catalyst 102 is mineralized with CO₂, alkali base 16, and alkaline solid industrial waste 70, optionally in the presence of one or more additives 22, to yield the aluminum-containing mineralized product 20. As noted, the aluminum-containing mineralized product may be used for further applications. The alkaline solid industrial waste may, in some embodiments, come from within the refinery. Thus, the alkaline solid industrial waste may be generated within the refinery, outside of the refinery, or both.

FIG. 5 depicts a fifth example embodiment of this invention. In this case, a direct air capture (DAC) system 120 is used as a source of carbon dioxide in a process similar to the ones described in the embodiments of FIGS. 1-5.

Technical effects of the embodiments of the invention may include, but are not limited to, the use of refinery waste materials (e.g., FCC catalyst fines or spent hydrotreated catalyst) for carbon capture purposes, which may reduce emissions associated with such facilities. Additionally, embodiments of the invention generate aluminum-containing carbonate products which may be used as feedstock for potential applications in concrete, cement, and other construction industries. Other Ca-, Mg-, and Al-containing refinery waste solids can also be mineralized using the processes described herein.

### EXAMPLES

The following examples are included to demonstrate embodiments of the disclosure. It should be appreciated by those of skill in the art that the techniques disclosed in the examples which follow represent techniques discovered by the inventors to function well in the practice of the disclosure.

Unless indicated to the contrary, the mineralization process of each of the following examples was carried out in a 100- or 300-ml autoclave (considered analogous to a small scale mineralization reactor, for the purposes of this disclosure), batch type, with mechanical stirring at 300 rpm using a temperature-controlled heating unit with a total reaction volume of 40-100 ml. The reactor was loaded with CO₂ at room temperature and heated to the desired temperature. After 1-3 hours of reaction for each process, the autoclave was allowed to cool to room temperature and was depressurized. The slurry solution was filtered. The filtrate was sent for Inductively Coupled Plasma Optical Spectroscopy analysis (ICP-OES) following ASTM D5673-16, EPA METHOD 200.7, or equivalent method. The obtained solids were analyzed by X-ray diffraction analysis, following guidance recommended by ASTM E3294-22 or equivalent method, Fourier Transform Infrared analysis (FTIR) following ASTM E1252 or equivalent, and thermogravimetric analysis (TGA) following ASTM E1131-20, ISO 11358 or equivalent method.

### Example Set 1

In connection with the example embodiments of FIGS. 1-3, a series of reactions were conducted across a range of temperatures (between 75° C. and 120° C.) and reaction times (between 1 h and 3 h). In these example reactions, 9 g of an aluminum-containing industrial solid waste (in these reactions, FCC fines in water) was mixed with 40 ml of deionized water, and the initial pH was adjusted to pH >9 using an alkali base (NaOH, in these reactions). The resulting mixture was introduced into the autoclave (300 ml). The autoclave was then loaded with pure CO₂ (10 atm), and heated to a temperature between 75° C. and 120° C. for a reaction time within the range of between 1 h and 3 h. After cooling down, the mixture was separated, and the filtrate was sent to ICP-OES analysis whereas the dried solid was sent for XRD, FTIR, and TGA analysis. XRD and FTIR confirmed CO₂ mineralization for the reactions by the presence of different Al, Na, or Ca carbonate compounds.

### Example Set 2

In connection with the example embodiments of FIGS. 1-3, a series of reactions were conducted across a range of temperatures (between 75° C. and 120° C.) and reaction times (between 1 h and 3 h). In these example reactions, 9 g of aluminum-containing industrial solid waste (FCC fines in water) was mixed with 40 ml of deionized water, and the initial pH was adjusted to pH >9 using NaOH. An organic additive (Na-EDTA, in these reactions) was also added. The resulting mixture was introduced into the autoclave (300 ml). The autoclave was loaded with pure CO₂ (10 atm), and heated to between 75° C. and 120° C. for between 1 h and 3 h. After cooling down, the mixture was separated, and the filtrate was sent to ICP-OES analysis whereas the dried solid was sent for XRD, FTIR, and TGA analysis. XRD and FTIR confirmed CO₂ mineralization for these reactions by the presence of different Al, Na, Mg, or Ca carbonate compounds.

### Example Set 3

In connection with the example embodiments of FIGS. 1-3, a series of reactions were conducted across a range of temperatures (between 75° C. and 120° C.) and reaction times (between 1 h and 3 h). In these example reactions, 9 g of aluminum-containing industrial solid waste (in this example, FCC fines in water) was mixed with 40 ml of deionized water, and the initial pH was adjusted to pH >9 using NaOH. The resulting mixture was introduced into the autoclave (300 ml). The autoclave was loaded with pure CO₂ (10 atm), and heated to between 75° C. and 120° C. for between 1 h and 3 h. After cooling down, the mixture was separated, and the filtrate was sent to ICP-OES analysis whereas the dried solid was sent for XRD, FTIR, and TGA analysis. XRD and FTIR confirmed CO₂ mineralization by the presence of an Al—Na-containing carbonate compounds.

### Example Set 4

In connection with the example embodiment of FIG. 3, a series of reactions were conducted across a range of temperatures (between 75° C. and 120° C.) and reaction times (between 1 h and 3 h). In these reactions, a total of 9 g mixture of aluminum-containing industrial solid waste (in this example, FCC fines in water) and Mg-containing minerals in a ratio spanning from (0.1 to 0.7) was mixed with 40 ml of deionized water, and the initial pH was adjusted to >9 using a NaOH. The mixture was introduced into the autoclave (300 ml), loaded with pure CO₂ (10 atm), and heated to between 75° C. and 120° C. for between 1 h and 3 h. After cooling down, the mixture was separated, and the filtrate was sent to ICP-OES analysis whereas the dried solid was sent for XRD, FTIR, and TGA analysis. XRD and FTIR confirmed CO₂ mineralization by the presence of Al—Na—Mg containing carbonate compounds.

### Example Set 5

In connection with the example embodiment of FIG. 3, a series of reactions were conducted across a range of temperatures (between 75° C. and 120° C.) and reaction times (between 1 h and 3 h). In these reactions, a total of 9 g mixture of aluminum-containing industrial solid waste (in this example, FCC fines in water) and Ca-containing minerals in a ratio spanning from (0.1 to 0.7) was mixed with 40 ml of deionized water, and the initial pH was adjusted to >9 using a NaOH; the mixture was introduced into the autoclave (300 ml), loaded with pure CO₂ (10 atm), and heated to between 75° C. and 120° C. for between 1 h and 3 h. After cooling down, the mixture was separated, and the filtrate was sent to ICP-OES analysis whereas the dried solid was sent for XRD, FTIR, and TGA analysis. XRD and FTIR confirmed CO₂ mineralization by the presence of an Al—Na—Ca containing carbonate compound.

### Example Set 6

In connection with the example embodiment of FIG. 3, a series of reactions were conducted across a range of temperatures (between 75° C. and 120° C.) and reaction times (between 1 h and 3 h). In these reactions, 9 gr of aluminum-containing industrial solid waste (in this example, FCC fines in water) was mixed with 40 ml of FCC-produced water, and the initial pH was adjusted to >9 using a NaOH; the mixture was introduced into the autoclave (300 ml), loaded with pure CO₂ (10 atm), and heated to between 75° C. and 120° C. for between 1 h and 3 h. After cooling down, the mixture was separated, and the filtrate was sent to ICP-OES analysis whereas the dried solid was sent for XRD, FTIR, and TGA analysis. XRD and FTIR confirmed CO₂ mineralization by the presence of an Al—Na-containing carbonate compound.

### PROPHETIC EXAMPLES

The following prophetic examples describe reactions that were not performed. However, it is believed that the carbon mineralization processes described herein would successfully produce an aluminum-containing carbonate material using spent hydrotreating catalyst as a feed.

### Prophetic Example Set 1

In connection with the example embodiment of FIG. 4, 9 g of spent hydrotreating catalyst, with particle size spanning from 100 to 400 mesh, would be mixed with 40 ml of deionized water, and the initial pH is adjusted to >9 using NaOH; the mixture would be introduced into the autoclave (300 ml), loaded with pure CO₂ (10 atm), and heated to between 75° C. and 120° C. for between 1 h and 3 h. After cooling down, the mixture would be separated, and the filtrate would be sent to ICP-OES analysis whereas the dried solid would be sent for XRD, FTIR, and TGA analysis. XRD and FTIR would likely confirm CO₂ mineralization by the presence of an Al—Na-containing carbonate compound.

### Prophetic Example Set 2

In connection with the example embodiment of FIG. 5, a total of 9 g mixture of spent hydrotreating catalyst and Mg or Ca-containing minerals in a ratio spanning from (0.1 to 0.7) would be mixed with 40 ml of deionized water, and the initial pH would be adjusted to >9 using a NaOH; the mixture would be introduced into the autoclave (300 ml), loaded with pure CO₂ (10 atm), and heated to between 75° C. and 120° C. for between 1 h and 3 h. After cooling down, the mixture would be separated, and the filtrate would be sent to ICP-OES analysis whereas the dried solid would be sent for XRD, FTIR, and TGA analysis. XRD and FTIR would likely confirm CO₂ mineralization by the presence of Al—Na—Mg or Al—Na—Ca containing carbonate compounds.

### Prophetic Example Set 3

In connection with the example embodiment of FIG. 5, 9 g of spent hydrotreating catalyst, with particle size spanning from 100 to 400 mesh, would be mixed with 40 ml FCC produced water, and the initial pH would be adjusted to >9 using NaOH; the mixture would be introduced into the autoclave (300 ml), loaded with pure CO₂ (10 atm), and heated to between 75° C. and 120° C. for between 1 h and 3 h. After cooling down, the mixture would be separated, and the filtrate would be sent to ICP-OES analysis whereas the dried solid would be sent for XRD, FTIR, and TGA analysis. XRD and FTIR would likely confirm CO₂ mineralization by the presence of an Al—Na-containing carbonate compound.

It will be understood that various modifications may be made to the embodiments disclosed herein. Therefore, the above description should not be construed as limiting, but merely as exemplifications of example embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

1. A process for carbon mineralization of petroleum refinery solid waste material, comprising:
providing an aluminum (Al)-containing industrial solid waste generated within a petroleum refinery, a carbon dioxide (CO₂) containing stream, and an alkali base to a mineralization reactor, wherein the petroleum refinery solid waste material comprises the aluminum-containing industrial solid waste; and
reacting the Al-containing industrial solid waste, the CO₂ containing stream, and the alkali base within the mineralization reactor under reaction conditions to produce a reactor product comprising an Al-containing carbonate product.

2. The process of claim 1, comprising subjecting the reactor product to separation and Postprocessing to produce a stream of isolated Al-containing carbonate product.

3. The process of claim 2, wherein the separation and Postprocessing produces an unreacted alkali base stream and an unreacted CO² stream.

4. The process of claim 3, comprising recycling the unreacted alkali base stream, the unreacted CO² stream, or both, back to the mineralization reactor.

5. The process of claim 3, wherein subjecting the reactor product to separation and Postprocessing comprises using a gas/liquid separator to separate a slurry comprising the Al-containing carbonate product from the unreacted CO² stream.

6. The process of claim 5, comprising filtering the slurry to produce the unreacted alkali base stream and a wet aluminum-containing carbonate product.

7. The process of claim 6, wherein subjecting the reactor product to separation and Postprocessing comprises Postprocessing the wet aluminum-containing carbonate product to dry, pelletize, or agglomerate the wet aluminum-containing carbonate product to produce the isolated aluminum-containing carbonate product.

8. The process of claim 1, wherein the Al-containing industrial solid waste comprises fluid catalytic cracking (FCC) catalyst fines having a particle size of less than 45 μm.

9. The process of claim 8, wherein the FCC catalyst fines have a particle size between 0.5 μm and 45 μm.

10. The process of claim 8, wherein providing the FCC catalyst fines to the mineralization reactor comprises directing the FCC catalyst fines from a fines recovery system of an FCC unit of the petroleum refinery to the mineralization reactor.

11. The process of claim 1, wherein the Al-containing industrial solid waste comprises a spent hydrotreating catalyst.

12. The process of claim 11, wherein the spent hydrotreating catalyst has a particle size of less than 149 μm.

13. The process of claim 12, comprising directing spent hydrotreating catalyst from a hydrotreater of the petroleum refinery to a particle size reduction system to reduce the particle size of the spent hydrotreating catalyst before it is provided to the mineralization reactor.

14. The process of claim 1, wherein the CO₂ containing stream is a point source stream or is a stream generated within the petroleum refinery, or both.

15. The process of claim 14, wherein a direct air capture system is a source of CO₂ for the CO₂ containing stream.

16. The process of claim 15, wherein the direct air capture system is located within the petroleum refinery.

18. The process of claim 1, wherein the alkali base comprises an alkaline solid industrial waste generated within the petroleum refinery or outside of the petroleum refinery, or a combination.

19. The process of claim 1, comprising using an additive within the mineralization reactor to enhance a rate of reaction between the Al-containing industrial solid waste, the CO₂ containing stream, and the alkali base.

20. The process of claim 19, wherein the additive comprises:
ethylene diamine tetraacetate (EDTA), ammonium bases, urea, betanine, amino acid-base compounds, transition-metal containing compounds comprising Zn, Cu, or Fe in oxide, hydroxide, or chloride form, or any combination of these.
